(19) United States
(12) Patent Application Publication
(10) Pub. No.: US 2015/0126479 A1
(43) Pub. Date: May 7, 2015

(54) AQUEOUS SOLUTIONS OF 1,2-BENZISOTHIAZOLIN-3-ONE

(71) Applicants: Raman Premachandran, Saddle Brook, NJ (US); Karen Winkowski, Springfield, NJ (US); Najeeb H. Hakimi, Edison, NJ (US)

(72) Inventors: Raman Premachandran, Saddle Brook, NJ (US); Karen Winkowski, Springfield, NJ (US); Najeeb H. Hakimi, Edison, NJ (US)

(73) Assignee: ISP Investments Inc., Wilmington, DE (US)

(21) Appl. No.: 14/117,171

(22) PCT Filed: May 9, 2012
(86) PCT No.: PCT/US12/37076

§ 371 Date: Jan. 13, 2015

Related U.S. Application Data
(60) Provisional application No. 61/485,799, filed on May 13, 2011.

(51) Int. Cl. A01N 43/80; A01N 39/00; A01N 31/02; A01N 31/06; A01N 35/04; A01N 33/12; A01N 47/44; A01N 25/02; A01N 37/10

(52) U.S. Cl. CPC A01N 43/80; A01N 25/02; A01N 39/00; A01N 31/02; A01N 37/10; A01N 35/04; A01N 33/12; A01N 47/44; A01N 31/06
USPC 514/161; 514/373

(57) ABSTRACT

What is described herein is an environment-friendly, highly aqueous solution of 1,2-benzisothiazolin-3-one (BIT) which is free from volatile organic compounds (VOC's), glycols, derivatives of glycols, glycerols and/or derivatives of glycerols. The composition comprises: (i) about 0.1% to about 30% by wt. of BIT; (ii) about 5% to about 15% by wt. of neutralizing agent; (iii) about 50% to about 85% by wt. of water; and (iv) about 0.1% to about 5% by wt. of chelating agent. The aqueous solution of BIT may further comprise at least one water soluble form of a co-biocide. The composition is efficient in protecting aqueous media against microbial attack in various industrial applications.

### FIELD OF THE INVENTION

The present application relates to an aqueous solution of biocidal compositions, and more particularly, to an aqueous clear solution of 1,2-benzisothiazolin-3-one (BIT) which is free from volatile organic compounds (VOC's), glycerols, derivatives of glycerols, glycols and/or derivatives of glycols.

### BACKGROUND OF THE INVENTION

1,2-benzisothiazolin-3-one (referred to hereinafter as “BIT”) is a well-known industrial biocide which is efficient in protecting aqueous media against microbial attack. It is effective as a bactericide and suited to various industrial applications such as metal working fluids, cooling tower water, emulsions, plastic film, paint, building materials, stucco, concrete, caulks, sealants, joints, adhesives, leather, wood, inks, pigment dispersions, drilling mud, clay slurries, agricultural applications, seed coatings, pesticide compositions, toiletry, household, cleaning, disinfecting, enzyme formulations, laundry products, and the like.

It is advantageous to provide BIT as a highly aqueous solution for its intended use in the various above specified fields. It has been observed in the recent past many of the liquid based BIT formulations explored are with glycol based solvents such as propylene glycols, polyethylene glycols, polyglycols, glycerols and etc. Unfortunately, the continuous oscillation in market price of glycols is a great concern for the manufacturers. As a result, formulations arising out of such glycol based solvents are not cost-effective for the users. Hence, it is advantageous to have highly aqueous solutions of BIT which are free from glycol based solvents.

Liquid formulations of BIT in amines have been disclosed. Particularly, it has been formulated as an aqueous dispersion and stable solution in an amine solvent as disclosed in U.K. Patent No. 1,191,253 and U.K. Patent No. 1,330,531. For some applications, these amine formulations are not attractive and are rarely used for indirect food contact applications, such as for instance for use in water-based adhesives which may be used in the food packaging industry, because the amines are volatile and tend to have an unpleasant odor. Furthermore, amine solutions of BIT may not be suitable for use as biocides in in-can preservation of lattices because amine solvents may cause yellowing of the latex. Amines are also capable of reacting with and deactivating certain biocides and this further limits the use of amine formulations of BIT when used with such biocides. To avoid these problems associated with amines, BIT is now generally formulated as an alkali metal salt in one or more water miscible solvents such as dipropylene glycol as disclosed in U.S. Pat. No. 4,188,376. Such formulations are stable solutions which withstand freeze-thaw temperature cycling, and, even if frozen recover on warming to regenerate a stable solution. Formulations of this type containing 20% BIT, and 65% dipropylene glycol, the remainder being water, wherein the BIT has been converted to sodium-BIT by reacting 1.1 moles sodium hydroxide with 1 mole BIT as described in Example 1 of said U.S. Pat. No. 4,188,376 is available commercially for many years as Proxel® GXL (Proxel is a registered trademark of Arch Chemicals).

A disadvantage of such formulations is their high pH, normally pH 12 or above, which can cause “pH-shock” and coagulation when added to a medium to be protected, such as an emulsion paint or latex, owing to the different pH of the medium. Further, the pH also influences corrosive properties of the streams flowing through the metal pipelines, preferably steel pipelines and equipments with steel pipeline, with high pH of biocide compositions leading to more corrosion.

The high pH is caused by the combination of the amount and type of solvent employed and also the amount of alkali both of which have hitherto been considered necessary to produce stable solutions of sodium-BIT. Indeed, in all the working examples of U.S. Pat. No. 4,188,376 a 10% excess of sodium hydroxide has been used relative to BIT in making the sodium salt.

U.S. Pat. No. 5,558,816 describes a BIT composition using 50 to 65% of dipropylene glycol as the solvent. These compositions had a lower pH (8.9-10) and a lower viscosity (60-180 mPas) than commercial products. However, dipropylene glycol is a volatile solvent and it contributed greatly to the high VOC of the composition. U.S. Pat. No. 5,585,033 describes BIT compositions which contained one or more polyglycol triols, e.g. glycerol ethoxylate or glycerol propoxylate, as the organic solvent, optionally including an organic co-solvent.

U.S. Pat. No. 4,923,887 discloses liquid formulations of BIT with ethoxylated (coconut alkyl)-amine, water, alcohols, 1,2-propylene glycol, dipropylene glycol, polyglycols, ether of glycols, or their mixture, as co-solvent. U.S. Pat. No. 5,276,047 discloses liquid formulations of BIT with triamines and triamine mixtures, water, glycols and alkylglycol ethers.

U.S. Pat. No. 7,666,887 and U.S. Pat. No. 7,105,555 disclose a neutral pH, VOC-free biocidal composition consisting essentially of by weight, about 0.1-30%, 1,2-benzisothiazolin-3-one (BIT), about 20-90% polyethylene glycol (PEG) of molecular weight 400 or more, about 0-3%, preferably 1.5-2.5% sodium hydroxide (NaOH), KOH or LiOH and about 0-15%, preferably 5-10% water. These compositions are stable at temperatures as low as −20° C. for an extended period of time. A preferred composition consists essentially of 20% BIT, 70% PEG-400, 2.1% NaOH and 7.9% water.

U.S. Pat. No. 5,684,025 and U.S. Pat. No. 5,585,033 disclose liquid formulations of 1,2-benzisothiazolin-3-one, and methods for making such formulations. Formulations according to this invention contain about 1 to 25 percent by weight 1,2-benzisothiazolin-3-one, about 3 to 7 percent by weight of sodium hydroxide, about 3 to 63 percent by weight of water and about 20 to 65 percent by weight of one or more polyglycol triols.

U.S. Pat. No. 4,751,311 discloses a concentrated aqueous formulation of isothiazolin-3-ones containing 5-30% urea are stable down to −13° C. at pH>9.

In view of foregoing facts, there remains a need for an environment-friendly, highly-aqueous BIT based antimicrobial compositions which is slightly alkaline, VOC-free, stable, glycerol-free, glycol-free and capable of exhibiting biocidal activity against gram (−) negative and gram (+) bacterial strains.

Accordingly, it is an object of this application to provide a new and improved aqueous solution of BIT composition which is stable, has a slightly alkaline pH, and is free from VOC's, organic co-solvents, glycerols, derivatives of glycerols, glycols and/or derivatives of glycols.

### SUMMARY OF THE INVENTION

What is described herein is an environment-friendly highly aqueous clear solution of 1,2-benzisothiazolin-3-one (BIT) comprising: (i) about 0.1 to about 30% by wt. of 1,2-benzisothiazolin-3-one; (ii) about 5% to about 15% by wt. of alkali metal salt; (iii) about 50% to about 85% by wt. of water; and (iv) about 0.1% to about 5% by wt. of chelating agent; and wherein said aqueous solution is free from volatile organic compounds (VOC), glycerols, derivatives of glycerols, glycols and/or derivatives of glycols.

In accordance with certain aspects, an aqueous solution of BIT is provided comprising high percentage levels of aqueous medium ranging from about 50% to about 85% of the total compositions.

Another important aspect of the present application is to provide an environment-friendly, slightly alkaline and stable aqueous composition of BIT which is free from VOC's, glycerols, derivatives of glycerols, glycols and/or derivatives of glycols.

According to one important aspect of the present application, the aqueous solution of BIT further comprises at least one water soluble forms of co-biocides selected from the group consisting of phenolic compounds, alkali metal salts of isothiazolinones, quaternary ammonium salts, triazine derivatives, guanidine compounds, biguanides, poly biguanides, salts of organic acids, fatty amines, diamines, triamines, Tetrakis (hydroxymethyl)phosphonium sulfate (THPS), 2,2-dibromo-3-nitrilopropionamide (DBNPA), salts of Zinc pyrithione (ZnPt), copper salts, thiocyanates, carbamates, dithiocarbamates, hydantoins, silver based compounds, copper based compounds or formaldehyde releasing compounds.

Yet another aspect of the present application is to provide an aqueous composition of BIT which is storage-stable, transit-stable, easily-flowable, non-drying, non-crystallizable, dilution-stable and easily incorporable in numerous aqueous based industrial applications.

In accordance with another aspect of the present application, the aqueous BIT compositions provided herein are capable of withstanding heat and cold exposure, wherein the composition is stable for at least two years at room or ambient temperature or stable for at least 5 freeze/thaw cycles wherein temperature cycled from 50° C. to −24° C. in every 24 hours or stable for at least 4 weeks at about 50° C.

An important embodiment of the present application is to employ a chelating agent for preparation of aqueous BIT solutions selected from the group consisting of hydroxy-carboxylic acids, aminocarboxylic acids, phosphonic acids, crown ethers, amino acids, ethylene diamine tetraacetic acid, nitrosotrihydroxy-dipropylamine, nitriloacetate, acetyl salicylate and/or gluconic acid salts.

According to another aspect of the present application, the aqueous BIT composition is capable of inhibiting or killing gram (+) bacterial strains, gram (−) bacterial strains, fungi, yeasts and/or mold spores.

In accordance with another aspect of the present application, a process for preparing an environment-friendly highly aqueous solution of 1,2-benzisothiazolin-3-one (BIT) comprises: (i) preparing a homogenous mixture of (a) pre-neutralized 1,2-benzisothiazolin-3-one (BIT); (b) optionally, at least one water soluble form of co-biocide; (c) a chelating agent; and (d) water by high shear mixing in a reactor for 30 minutes; and (ii) adding an antifoaming agent to suppress the formation of foam if any.

In accordance with further objective of the present application, the aqueous solution of BIT prepared according to the above said process is employed in the field of paint, latex, coatings, building materials, stucco, concrete, caulks, sealants, joints, adhesives, leather, wood, inks, pigment dispersions, metal working fluids, drilling mud, clay slurries, agricultural applications, seed coatings, pesticide compositions, toiletry, household, cleaning, disinfecting, enzyme formulations, in-can preservation, laundry amongst other.

### DETAILED DESCRIPTION OF THE INVENTION

While this specification concludes with claims particularly pointing out and distinctly claiming that, which is regarded as the invention it is anticipated that the invention can be more readily understood through reading the following detailed description of the invention and study of the included examples.

By the term “comprising” herein is meant that various optional, compatible components can be used in the compositions herein, provided that the important ingredients are present in the suitable form and concentrations. The term “comprising” thus encompasses and includes the more restrictive terms “consisting of” and “consisting essentially of” which can be used to characterize the essential ingredients such as water, BIT, water soluble form of co-biocide, chelating agent and neutralizing agent of the present aqueous BIT compositions.

All percentages, parts, proportions and ratios as used herein, are by weight of the total composition, unless otherwise specified. All such weights as they pertain to listed ingredients are based on the active level and, therefore; do not include solvents or by-products that may be included in commercially available materials, unless otherwise specified.

All references to singular characteristics or limitations of the present invention shall include the corresponding plural characteristic or limitation, and vice-versa, unless otherwise specified or dearly implied to the contrary by the context in which the reference is made.

Numerical ranges as used herein are intended to include every number and subset of numbers contained within that range, whether specifically disclosed or not. Further, these numerical ranges should be construed as providing support for a claim directed to any number or subset of numbers in that range.

The term “about” can indicate a variation of 10 percent of the value specified; for example about 50 percent carries a variation from 45 to 55 percent. For integer ranges, the term about can include one or two integers greater than and less than a recited integer.

As used herein, the words “preferred,” “preferably” and variants refer to embodiments of the invention that afford certain benefits, under certain circumstances. However, other embodiments may also be preferred, under the same or other circumstances. Furthermore, the recitation of one or more preferred embodiments does not imply that other embodiments are not useful, and is not intended to exclude other embodiments from the scope of the invention.

References herein to “one embodiment,” “one aspect” or “one version” or “one objective” of the invention include one or more such embodiment, aspect, version or objective, unless the context clearly dictates otherwise.

All publications, articles, papers, patents, patent publications, and other references cited herein are hereby incorporated herein in their entireties for all purposes to the extent consistent with the disclosure herein.

The term “biocide” or “antimicrobial” as used herein is to be understood to refer to agents such as germicides, bactericides, fungicides, algicides, aquaticides, herbicide, insecticide, larvicide, pesticide, rodenticide, taeniacide, plant growth regulators and the like, which are used for their ability to inhibit growth of and/or destroy biological and/or microbiological species such as bacteria, fungi, algae, caterpillar, insects, larvae, mildew, rodents, spider, worm and the like.

Herein, “stable” and “stability” mean a composition which is significantly unaffected in chemical nature, physical homogeneity and/or color upon exposure to conditions reasonably expected to be incurred in transport, storage and use. Stability may be determined either by empirical observation or by suitable methods of chemical and/or physical examination that would be known to one of skill in the art.

The term “environmentally friendly” means, without limitation, no adverse affect on the environment. More particularly, environmentally friendly (also eco-friendly, nature friendly, and green) are synonyms used to refer to goods and services, laws, guidelines and policies considered to inflict minimal or no harm on the environment or may rebuild or renew resources through their use.

The term “sequestering agent” and “chelating agent” is used synonymously in the entire application. Further, the “sequestering agent” or “chelating agent” as used in this specification and claims relates to a compound which is capable of bonding or complexing a metal ion between two or more atoms of the compound, thereby neutralizing or controlling harmful effects of such metal ions, wherein holding or bonding of a metal ion is through combination of one or more different types of bonds including coordination and/or ionic bonds.

The term “Volatile Organic Compounds (VOC)-free” as used herein referring to a composition of the present application means that no external solvent constituent has been added in the present aqueous composition at any point of time and it should be understood by one of ordinary skill in the art that residual solvents may be present inherently in commercially available or synthesized products which may or may not be part of the aqueous composition of the present application and wherein the inherent presence of residual solvent is not precluded by use of the term “Volatile Organic Compounds (VOC)-free”.

The present application provides an environment-friendly highly aqueous solution of 1,2-benzisothiazolin-3-one (BIT) comprising: (i) about 0.1 to about 30% by wt. of 1,2-benzisothiazolin-3-one; (ii) about 5% to about 15% by wt. of alkali metal salt; (iii) about 60% to about 80% by wt. of water; and (iv) about 0.1% to about 5% by wt. of chelating agent; and wherein said aqueous solution is free from volatile organic compounds (VOC's), glycerols, derivatives of glycerols, glycols and/or derivatives of glycols.

The aqueous solution of BIT of the present application may further comprise at least one water soluble form of co-biocide is selected from the group consisting of phenolic compounds, alkali metal salts of isothiazolinones, quaternary ammonium salts, triazine derivatives, guanidine compounds, biguanides, poly biguanides, salts of organic acids, fatty amines, diamines, triamines, salts of pyrithione, copper salts, thiocyanates, carbamates, dithiocarbamates, hydantoins, silver based compounds, copper based compounds and/or formaldehyde releasing compounds.

The preferred water soluble forms of co-biocide of the present application include, but are not limited to, formaldehyde, glutaraldehyde, propionic acid salt, octanoic acid salt, salicylic acid salt, dehydroacetic acid salt, bronopol, phenoxy ethanol, menthol, eugenol, capryl alcohol, coco amine acetate, N-dodecyl-1,3-propanediamine, bis-(3-aminopropyl) dodecylamine, chlorhexidine, alexidine, sodium hydroxymethylglycinate, dimethyloldimethylhydantoin, polyhexamethylene biguanide, diazolidinyl urea, imidazolidinyl urea, polymethoxy bicyclic oxazolidines, benzyl alcohol, hexamidine isethionate, chlorobutanol, dibromopropamidine, tetrakis (hydroxymethyl)phosphonium sulfate (THPS), 2,2-dibromo-3-nitrilopropionamide (DBNPA), tri-n-butyl tetradecyl phosphonium chloride (TPC), methylene bis(thiocyanate) (MBT), alkyl dithiocarbamates, alkylene dithiocarbamates, 2-hydroxypyridine-N-oxide, N-nitroso-N-cyclohexyl-hydroxylamine, and/or 8-hydroxy-quinoline.

The various water soluble form of pyrithione salt is selected from the group consisting of pyrithione acid, ammonium pyrithione, tert-butyl-amine pyrithione, calcium pyrithione, dithiobis(pyridine-N-oxide), a magnesium salt adduct of dithiobis (pyridine-N-oxide), sodium pyrithione, potassium pyrithione, lithium pyrithione or zinc pyrithione.

The water soluble form of silver based biocides is preferably selected from metallic silver and silver based compounds, such as silver oxide, silver chloride, silver bromide, silver iodide. Further, the mixtures of silver and/or silver compounds can be employed with one or more other water soluble forms of biocidal compounds that are known in the art.

The copper based water soluble forms of antibacterial compounds for the present application, include but are not limited to, copper, cuprous oxide, cupric acetate, cupric chloride, cupric nitrate, cupric oxide, cupric sulfate, cupric sulfide, cupric stearate, cupric cyanide, cuprous cyanide, cuprous stannate, cuprous thiocyanate, cupric silicate, cuprous chloride, cupric iodide, cupric bromide, cupric carbonate and/or cupric fluoroborate,

Suitable salts of 2-methyl-4-isothiazolin-3-one (MIT), 5-Chloro-2-methyl-4-isothiazolin-3-one (CMIT), 2-Octyl-4-isothiazolin-3-one (OIT) can be employed alone or in combination as a co-biocide for the present application.

The aqueous solution of BIT comprises significantly high-content of aqueous medium, of at least 50% of the total composition. The preferred range of aqueous medium is from about 50% to about 85% by wt. The most preferred range of aqueous medium is from about 70% to about 80% by wt. of the total composition.

In order to prepare an aqueous BIT composition, the preferred aqueous medium can be any type of water that is known in the art for this purpose and preferably selected from treated-water, purified-water, distilled water, de-ionized water, double distilled water, triple distilled water, tap water, de-mineralized water, reverse-osmosis water alone or in combination thereof. This added water to the composition is in addition to water found in or with other components of the present application. The water should be suitable for human consumption and the composition should not be substantially detrimentally, affected by the inclusion of the water.

Embodiments of the present application use a neutralizing agent to produce neutralized BIT for preparing the aqueous BIT compositions. The neutralizing agent is selected from the group including, but not limited to, alkali metal salts, alkaline earth metals, alkanolamines, alkyl amines, mono-alkyl alkanolamines, di-alkyl alkanolamines, tri-alkyl alkanolamines, primary amines, secondary amines, tertiary amines, quaternary amines and/or alkyl tertiary amines, alkoxylated amines, methoxylated alkylamines, ethoxylated alkylamines, alkoxylated alkanolamines, phenol amines, polymeric amines, alone or in combination.

The “alkali metal salt” or “alkaline earth metal salts” used to neutralize the BIT is not particularly limited as long as it is a salt with an alkali metal. Specific examples of the alkali metal salt include sodium salts, potassium salts, magnesium salts, calcium salts or the like, with sodium/potassium salts or the like being preferable example. Specific examples of the base containing the alkali metal include but are not limited to sodium hydroxide, sodium ethoxide, sodium methoxide, sodium hydride, potassium hydroxide, potassium ethoxide, potassium methoxide, potassium hydride and solutions of the foregoing.

According to one embodiment of the present application, the homo or copolymers of polyamines, polyimines, polyalkyleneimines can be employed in present application as a neutralizing agent. The preferred polyalkyleneimines are polyethyleneimine (referred to hereinafter as “PEI”), polyisopropyleneimines and polypropyleneimines. The generic structure of the PEI of the present application is having a repeating unit of —[—CH₂—CH₂—NH—]ₙ—, and may be homopolymers, or polymers formed by the reaction of polyethylenimine with ethylene oxide or epichlorohydrin. The PEI is produced by polymerization of ethyleneimine and may not have complete linear structure, but instead may have a branched structure including primary, secondary and tertiary amino nitrogen atoms. Particularly, the linear or branched PEI compounds with one or more nitrogen comprising heterocyclic compounds are effectively being employed in the present application. The commercially available and suitable PEI's for the preparation of aqueous BIT based biocidal compositions, include but are not limited to, Lupasol®, Lupasol SC 61B®, Lupasol G-35®, Lupasol-P®, Lupasol-PS®, Lupasol-(water-Free)®, Polymin P® from BASF Corporation. The PEI's from Polymer Enterprises or Nippon Soda, include but are not limited to, Epomin SP₀₁₂®, Epomin P₁₀₅₀®, Epomin SP₁₀₃®, Epomin SP₀₀₃®, Epomin SP₀₀₆® and in the similar lines various other PEI's suitable for use of present application include but are not limited to Polyazinidine®, Corcat®, Montek® and the like.

The preferable alkyl amines include but not limited to monoethylamine, diethylamine, triethylamine, monoisopropylamine, diisopropylamine, monobutylamine, dibutylamine, tributylamine, monoamylamine, dimethylethylamine, dimethyl isopropylamine, ethyldiisopropylamine, sec-butylamine, tetramethylpropylenediamine, diethylaminopropylamine, 3-methoxypropylamine, dimethylaminopropylaminopropylamine, 3-isopropoxypropylamine, decyl dimethyl tertiaryamine, nonyl dimethyl tertiaryamine, octyl dimethyl tertiaryamine, heptyl dimethyl tertiaryamine, hexyl dimethyl tertiaryamine, pentyl dimethyl tertiaryamine, butyl dimethyl tertiaryamine, propyl dimethyl tertiaryamine, dimethyl cocamine, dimethyl palmitamine, dioctylamine, dimethyl stearamine, dimethyl soyamine, soyamine, myristyl amine, tridecyl amine, ethyl stearylamine, N-tallowpropane diamine, ethoxylated stearylamine, dihydroxy ethyl stearylamine, arachidylbehenylamine, dimethyl lauramine, stearylamine hydrochloride, soyamine chloride, stearylamine formate, N-tallowpropane diamine dichloride, amodimethicone, stearamido propyl dimethyl amine, stearamidopropyl dimethylamine citrate, palmitamidopropyl diethylamine, cocamidopropyl dimethylamine lactate, distearyldimonium chloride, dicetyldimonium chloride, guar hydroxypropyltrimonium chloride, and the like.

The commercially available and suitable alkylamines for the preparation of aqueous-BIT compositions of the present application include, but are not limited to, AT-1095, AT-1295, AT-1495, AT-1695A, AT-1895A, AT-1270, AT-121416, AT-1214 and/or AT-1822A manufactured and marketed by PG Chemicals.

The suitable organic or inorganic sequestering or chelating is selected from the group comprising gluconates, sorbitals, mannitols, carbonates, hydroxamates, catechols, α-amino carboxylates, alkanolamines, metal-ion sequestrants, hydroxy-carboxylic acids, aminocarboxylic acids, amino polycarboxylic acids, polyamines, polyphosphates, phosphonic acids, crown ethers, amino acids, polycarboxylic acids, cyclodextrin, phosphonates, polyacrylates or polymeric polycarboxylates and condensed phosphates. However, the particular sequestering or chelating agents, include but are not limited to, acetic acid, adenine, adipic acid, ADP, alanine, alanine, albumin, arginine, ascorbic acid, asparagine, aspartic acid, ATP, benzoic acid, n-butyric acid, casein, citraconic acid, citric acid, cysteine, dehydracetic acid, desferri-ferrichrysin, desferri-ferrichrome, desferri-ferrioxamin E, 3,4-dihydroxybenzoic acid, diethylenetriaminepentaacetic acid (DTPA), hydroxylpropylenediaminetetraacetic acid (DPTA), dimethylglyoxime, dimethylpurpurogallin, EDTA, glutamic acid-N,N-diacetic acid tetrasodium salt (GLDA-Na₄), formic acid, fumaric acid, globulin, gluconic acid and its alkali metal salts, glutamic acid, glutaric acid, glycine, glycolic acid, glycylglycine, glycylsarcosine, guanosine, histamine, salicylic, pimalic acid, sulfamic acid, salicylic, glutaric, malonic acid, 1,10-phenanthroline, 2-pyridylacetic acid, 5-formylfuran sulfonic acid, N-tris(hydroxymethyl)methyl-2-aminoethanesulfonic acid, itaconic acid, chelidonic acid, 3-methyl-1,2-cyclopentanedione, glycolamide, histidine, 3-hydroxyflavone, inosine, iron-free ferrichrome, isovaleric acid, itaconic acid, kojic acid, lactic acid, leucine, lysine, maleic acid, malic acid, methionine, methylsalicylate, nitrilotriacetic acid (NTA), ornithine, orthophosphate, oxalic acid, oxystearin, phenylalanine, phosphoric acid, phytate, pimelic acid, pivalic acid, polyphosphate, proline, propionic acid, purine, pyrophosphate, pyruvic acid, riboflavin, salicylaldehyde, salicyclic acid, sarcosine, serine, sorbitol, succinic acid, tartaric acid, tetrametaphosphate, thiosulfate, threonine, trimetaphosphate, triphosphate, tryptophan, uridine diphosphate, uridine triphosphate, n-valeric acid, valine, xanthosine, triethylenetetraaminehexaacetic acid, N,N′-bis(o-hydroxybenzyl)ethylenediamine-N,N′ diacteic acid, ethylenebis-N,N′-(2-o-hydroxyphenyl)glycine, acetohydroxamic acid, desferroxamine-B, disulfocatechol, dimethyl-2,3-dihydroxybenzamide, mesitylene catecholamide (MECAM), 1,8-dihydroxynaphthalene-3,6-sulfonic acid, and 2,3-dihydroxynaphthalene-6-sulfonic acid, siderophores molecules, N,N-dicarboxymethyl-2-aminopentanedioic-acid, diethylenetriaminepentaacetic-acid, ethylene-diaminetetraacetates, nitriloacetates or N-(2-hydroxyethyl)nitrilodiacetates), 2,2-dichloropropionic acid, 2,2-dibromobutyric acid, trifluoroacetic acid, tribromoacetic acid, trichloroacetic acid, 2,3-dibromopropionic acid, 2,2-dichlorovaleric acid, 3-nitropropionic acid, triiodoacetic acid, 3(2,2,2-trichloroethoxy)propionic acid, 4-nitro-2-chlorobutyric acid, 2-bromo-2-nitropropionic acid, 2-nitroacetic acid, 2,4-dihydroxyphenyl acetic acid, 2,4-dichlorophenyl acetic acid, 3(2′,4′-dibromophenoxy)propionic acid, 3(3′,5′-dinitrophenoxy)propionic acid, 3-phenyl-2,3-dibromopropionic acid, 3,5-dinitrosalicylic acid, 3(3′-bromo-4′-nitrophenyl)propionic acid, 3(3′,4′-dihydroxyphenyl)propionic acid alone or in combination. Further, information on sequestering and chelating agents is disclosed in T. E. Furia, CRC Handbook of Food Additives, 2^{nd} Edition, pp. 271-294 (1972), and M. S. Peterson and A. M. Johnson (Eds.), Encyclopedia of Food Science, pp. 694-699 (1978) are incorporated herein by reference in its entirety. The most preferred sequestering agent of the present application is glutamic acid-N,N-diacetic acid tetrasodium salt (GLDA-Na₄). The preferred usable range of chelating agent is from about 0.01 to 5.0% by weight, particularly 0.01 to 2% by weight, based on the total aqueous BIT composition.

Optionally, a surfactant can be used to prepare highly aqueous BIT compositions of the present application. The organic surfactant material is preferably anionic, nonionic or ampholytic in nature. Examples of surface active agents used in the present application are given in Corrigan, O. I.; Healy, A. M. “Surfactants in Pharmaceutical Products and Systems” in Encyclopedia of Pharmaceutical Technology 2^{nd} ed. Taylor and Francis, 2006, pp 3583-3596. In a preferred embodiment, the aqueous solution is essentially free of any surfactants that may contribute to VOC.

Useful anionic surface active agents include sulfonic acid types, such as salts of alkanesulfonic acid, alphaolefinsulfonic acid, alkylbenzenesulfonic acid, alkylnaphthalenesulfonic acids, acylmethyltaurines, and dialkylsulfosuccinic acids, alkylsulfuric ester, sulfated oils, sulfated olefins, polyoxyethylene alkyl ether sulfuric ester salts, carboxylic acid types, e.g., fatty acid salts and alkylsarcosine salts and phosphoric acid ester types, such as alkylphosphoric ester salts, polyoxyethylene alkyl ether phosphoric ester salts, and glycerophosphoric ester salts.

Examples of water-soluble nonionic surfactants are condensation products of ethylene oxide with various reactive hydrogen-containing compounds reactive therewith having long hydrophobic chains (e.g. aliphatic chains of about 12 to 20 carbon atoms), which condensation products (“ethoxamers”) contain hydrophilic polyoxyethylene moieties, such as condensation products of poly(ethylene oxide) with fatty acids, fatty alcohols, fatty amides, polyhydric alcohols (e.g. sorbitol, tween, span and the like), polypropyleneoxide (e.g. Pluronic materials), poloxamers, polyoxyethylene sorbitan esters, fatty alcohol ethoxylates, alkylphenol ethoxylates, tertiary amine oxides, tertiary phosphine oxides and/or dialkyl sulfoxides. Suitable amphoteric surfactants include without limitation derivatives of C₈₋₂₀ aliphatic secondary and tertiary amines having an anionic group such as carboxylate, sulfate, sulfonate, phosphate or phosphonate.

Importantly, a sulfosuccinate based anionic surfactants can be employed for the preparation of highly aqueous BIT compositions. The sulfosuccinate type surfactants are mild surfactants amongst all the anionic surfactants and they are similar to alkyl sulfonates. Sulfosuccinate surfactants are of great interest because of their excellent properties such as foaming, strong wetting, emulsifying and solublizing properties, extraordinary surface activity, and effective reduction of surface tension, biodegradability, extreme mildness and low critical micelle concentration (CMC).

The suitable sulfosuccinate surfactant is selected from the group consisting of sulfosuccinate monoester, sulfosuccinate diester, monoalkyl sulfosuccinate, dialkyl sulfosuccinate, alkylaryl sulfosuccinate, alkylcycloalkyl sulfosuccinate or their alkali metal salts. The preferred sulfosuccinate surfactants are selected from the group including but are not limited to lauryl sulfosuccinate, laureth sulfosuccinate, laureth-5 sulfosuccinate, ricinoleamide MEA sulfosuccinate, undecyleneamide MEA sulfosuccinate, diisobutyl sulfosuccinate, dioctyl sulfosuccinate, dihexyl sulfosuccinate, dicyclohexyl sulfosuccinate, diisodecyl sulfosuccinate, diisotridecyl sulfosuccinate, di-2-ethylhexyl sulfosuccinate, di-2-methylamyl sulfosuccinate, dimethylamyl sulfosuccinate, dibutylhexyl sulfosuccinate, diisooctyl sulfosuccinate or their alkali metal salts alone or in combination. The commercially available sulfosuccinate based surface active agents include, but are not limited to, AEROSOL OT, AEROSOL EF800, AEROSOL MA80, AEROSOL OT 100, AEROSOL IB-45, MACKANATE DC-50, SOLE TERGE-8, AEROSOL 18, AEROSOL 22, AEROSOL A102, AEROSOL OT-75, AEROSOL OT70-PG, AEROSOL OTS, AEROSOL TR70, AEROSOL GPG, AEROSOL AY, AEROSOL 1B, NEKAL WS25 and AEROSOL A196. These surface active agents are preferably used in range of 0.01 to 10% by weight, particularly 0.1 to 3% by weight, based on the total aqueous biocide dispersion composition.

In accordance with another aspect of the present application, the aqueous BIT composition is capable of inhibiting or killing microorganisms including gram (+) bacterial strains, gram (−) bacterial strains, yeasts, fungi, molds and/or spores.

The gram (+) and gram (−) bacterial strains include, but are not limited to, the following list of genus Actinobacteria, Actinomyces, Bacillales, Bacillus, Clostridium, Corynebacterium, Enterococcus, Lactobacillales, Listeria, Nocardia, Propionibacterium, Rhodococcus equi, Sarcina, Solobacterium, Staphylococcus, Streptococcus, Acetic acid bacteria, Acinetobacter, Bacteroides, Burkholderia, Bdellovibrio, Coxiella, Cyanobacteria, Cytophaga, Enterobacter, Enterobacteriaceae, Escherichia, Fusobacterium, Haemophilus, Helicobacter, Klebsiella, Legionella, Leptotrichia, Moraxella, Neisseria, Proteobacteria, Proteus, Pseudomonas, Rickettsia, Salmonella, Serratia, Shigella, Spirochaete, Stenotrophomonas, Typhus, Vampirococcus, Verminephrobacter, Vibrio, Wolbachia.

Further, the examples of fungi to which, the solutions of the present application are applicable include but are not limited to: Alternaria alternata, Aspergillus flavus, Aspergillus terreus, Aspergillus fumigatus, Aspergillus repens, Aspergillus versicolor, Candida albicans, Chaetomium globosum, Cladosporium cladosporioides, Cladosporium herbarum, Cladosporium sphaerospermum, Coniophora puteana, Curvularia genticulata, Diplodia natalensis, Epidermophytonfloccosum, Fusarium oxysporum, Gliocladium virens, Gloeophyllum trabeum, Humicola grisea, Lecythophora mutabilis, Lentinus cyaihiformis, Lentinus lepidus, Memnionella echinata, Mucor indicus, Mucor racemosus, Oligoporus placenta, Paecilomyces variotii, Penicillium citrinum, Penicillium funiculosum, Penicillium ochrochloron, Penicillium purpurogenum, Penicillium pinophilum, Penicillium variabile, Petriella setifera, Phanerochaete chrysosporium, Phoma violacea, Poria placenta, Rhodotorula rubra, Schizophyllum commune, Sclerophoma phytiophila, Scopulariopsis brevicaulis, Serpula laaymans, Sporobolomyces roseus, Stemphyliwn dendriticum, Trichophyton mentagrophytes, Trichurus spiralis, Trichophyton rubruni, Ulocladium atrum and Ulocladium chartarum.

In another embodiment of present application, the aqueous BIT composition is stable for at least two years at room temperature or stable for at least about 5 freeze/thaw cycles when the temperatures is cycled from 50° C. to −24° C. in every 24 hours or stable for at least 4 weeks at about 50° C.

The aqueous BIT composition of the present application is easily flowable by its own gravity, or through any conventional, mechanical or pneumatic pump known in the art.

Further, the aqueous composition of the present application does not dry up on storage or on transit for at least of 18 months at room/ambient temperature.

The aqueous composition of the present application does not crystallize-out or precipitate-out during storage or in transit.

In a preferred embodiment of the present application, an environment-friendly highly aqueous solution of 1,2-benzisothiazolin-3-one (BIT) comprises: (i) about 0.1 to about 30% by wt. of 1,2-benzisothiazolin-3-one; (ii) about 5% to about 15% by wt. of potassium hydroxide (KOH); (iii) about 50% to about 85% by wt. of water; and (iv) about 0.1% to about 5% by wt. of glutamic acid-N,N-diacetic acid tetrasodium salt; and wherein said aqueous solution is free from volatile organic compounds (VOC's), glycerols, derivatives of glycerols, glycols and/or derivatives of glycols.

In a preferred embodiment of the present application, an environment-friendly highly aqueous solution of 1,2-benzisothiazolin-3-one (BIT) comprises: (i) about 0.1% to about 30% by wt. of 1,2-benzisothiazolin-3-one; (ii) optionally, 0.1% to about 20% by wt. of at least one water soluble form of co-biocide selected from a group consisting of formaldehyde, glutaraldehyde, propionic acid salt, octanoic acid salt, salicylic acid salt, dehydroacetic acid salt, bronopol, phenoxy ethanol, menthol, eugenol, capryl alcohol, coco amine acetate, N-dodecyl-1,3-propanediamine, bis-(3-aminopropyl)dodecylamine, chlorhexidine, alexidine, sodium hydroxymethylglycinate, dimethyloldimethylhydantoin, polyhexamethylene biguanide, diazolidinyl urea, imidazolidinyl urea, polymethoxy bicyclic oxazolidines, benzyl alcohol, hexamidine isethionate, chlorobutanol, dibromopropamidine, tetrakis (hydroxymethyl)phosphonium sulfate (THPS), 2,2-dibromo-3-nitrilopropionamide (DBNPA), tri n-butyl tetradecyl phosphonium chloride (TPC), methylene bis(thiocyanate) (MBT), alkyl dithiocarbamates, alkylene dithiocarbamates, 2-hydroxypyridine-N-oxide, N-nitroso-N-cyclohexyl-hydroxylamine or 8-hydroxy-quinoline; (iii) about 5% to about 15% by wt. of potassium hydroxide (KOH); (iv) about 50% to about 85% by wt. of water; and (v) about 0.1% to about 5% by wt. of glutamic acid-N,N-diacetic acid tetrasodium salt; and wherein said aqueous solution is free from volatile organic compounds (VOC's), glycerols, derivatives of glycerols, glycols and/or derivatives of glycols.

One important aspect of the present application is to provide a process for preparing an environment-friendly highly aqueous solution of 1,2-benzisothiazolin-3-one (BIT) comprising: (i) preparing a homogenous mixture of (a) pre-neutralized 1,2-benzisothiazolin-3-one (BIT); (b) optionally, at least one water soluble form of co-biocide; (c) a chelating agent; and (d) water by high shear mixing in a reactor for 30 minutes; and (ii) adding an antifoaming agent to suppress the formation of foam if any.

The aqueous BIT composition of present application can include at least one antifoaming agent if any foam is generated during the process. About 0.1% wt to about 5.0% wt of antifoaming or defoamers are employed to stop any unwanted foam generated while manufacturing highly aqueous BIT composition. The preferred antifoaming agent is selected from a group consisting of silicone based compounds, alcohols, mineral spirits, acetylene diols, polysiloxanes, organosiloxanes, reaction products of silicon dioxide and organosiloxane polymer or polydimethylsiloxanes alone or in combination.

The following is a representative list of some of the numerous possible applications of aqueous BIT composition. It should be understood that this list is presented for illustrative purposes only and does not represent any limitation as to possible applications.

The aqueous solution of BIT is preferably employed in the field of in-can preservation, paint, building materials, stucco, concrete, caulks, sealants, joints, adhesives, leather, wood, inks, pigment dispersions, metal working fluids, drilling mud, clay slurries, agricultural applications, seed coatings, pesticide compositions, toiletry, household, cleaning, disinfecting, enzyme formulations, latex, paint, coatings and/or laundry.

Further, the present invention is illustrated in detail by way of the below given examples. The examples are given herein for illustration of the invention and are not intended to be limiting thereof.

### Example 1

Aqueous solution of BIT (~10%)

| Ingredients | Wt % |
|---|---|
| Water | 80.57 |
| BIT (84% A.I.) | 11.43 |
| Potassium hydroxide (50% solution) | 8.00 |

pH of the solution is 8.5-9.0

### Example 2

Aqueous solution of BIT (~10%) with reduced KOH

| Ingredients | Wt % |
|---|---|
| Water | 81.69 |
| BIT (84% A.I.) | 11.31 |
| Potassium hydroxide (50% solution) | 7.00 |

pH of the solution is 8.0-8.5

### Example 3

Aqueous solution of BIT (~15%) with reduced KOH

| Ingredients | Wt % |
|---|---|
| Water | 71.49 |
| BIT (84% A.I.) | 17.86 |
| Potassium hydroxide (50% solution) | 10.65 |

pH of the solution is 8.5-8.8

### Example 4

Aqueous solution of BIT (~19%) and 2% surfactant

| Ingredients | Wt % |
|---|---|
| Water | 61.38 |
| BIT (84% A.I.) | 22.62 |
| Potassium hydroxide (50% solution) | 14.00 |
| Proprietary Surfactant (75% A.I.) | 2.00 |

pH of the solution is 8.0-9.0

### Example 5

Aqueous solution of BIT (~19%) and chelating agent

| Ingredients | Wt % |
|---|---|
| Water | 61.93-61.97 |
| BIT (84% A.I.) | 22.62 |
| Potassium hydroxide (50% solution) | 14.00 |
| Glutamic acid, N,N-diacetic acid tetrasodium | 0.37-0.39 |
| salt (GLDA-Na₄) | |

pH of the solution is 8.5

### Example 6

Aqueous solution of BIT (~15%),
Polyethyleneimine and chelating agent

| Ingredients | Wt % |
|---|---|
| Water | ≈68.64 |
| BIT (84% A.I.) | 17.86 |
| Potassium hydroxide (50% solution) | 10.50 |
| Glutamic acid, N,N-diacetic acid tetrasodium | ≈0.19 |
| salt (GLDA-Na₄) | |
| Polyethyleneimine (PEI) | 2.50 |

pH of the solution is 8.0

### Example 7

Aqueous solution of BIT (~15%),
Polyethyleneimine and chelating agent

| Ingredients | Wt % |
|---|---|
| Water | ≈66.14 |
| BIT (84% A.I.) | 17.86 |
| Potassium hydroxide (50% solution) | 10.50 |
| Glutamic acid, N,N-diacetic acid tetrasodium | ≈0.19 |
| salt (GLDA-Na₄) | |
| Polyethyleneimine (PEI) | 5.00 |

pH of the solution is 8.6

### Example 8

Aqueous solution of BIT (~20%) and chelating agent

| Ingredients | Wt % |
|---|---|
| Water | ≈62.20 |
| BIT (84% A.I.) | 22.62 |
| Potassium hydroxide (50% solution) | 12.50 |
| Glutamic acid, N,N-diacetic acid tetrasodium | ≈2.40 |
| salt (GLDA-Na₄) | |

pH of the solution is 8.7

### Example 9

Aqueous solution of BIT (~10%) and chelating agent

| Ingredients | Wt % |
|---|---|
| Water | ≈80.40 |
| BIT (84% A.I.) | 11.85 |
| Potassium hydroxide (50% solution) | 7.50 |
| Glutamic acid, N,N-diacetic acid tetrasodium | ≈0.25 |
| salt (GLDA-Na₄) | |

pH of the solution is 8.5

### Example 10

Aqueous solution of BIT (~19%), Bronopol and chelating agent

| Ingredients | Wt % |
|---|---|
| Water | 43.01-62.93 |
| Bronopol | 0.1-20 |
| Benzisothiazolinone (84% A.I.) | 22.6 |
| Potassium hydroxide (50% solution) | 14.00 |
| Glutamic acid, N,N-diacetic acid tetrasodium | 0.37-0.39 |
| salt (GLDA-Na₄) | |

pH of the solution is 9.0

### Example 11

Aqueous solution of BIT, CMIT/MIT and chelating agent

| Ingredients | Wt % |
|---|---|
| Water | 58.01-62.93 |
| CMIT/MIT | 0.1-5.0 |
| Benzisothiazolinone (84% A.I.) | 22.6 |
| Potassium hydroxide (50% solution) | 14.00 |
| Glutamic acid, N,N-diacetic acid tetrasodium | 0.37-0.39 |
| salt (GLDA-Na₄) | |

pH of the solution is 9.0

### Example 12

Aqueous solution of BIT, Phenoxy ethanol and chelating agent

| Ingredients | Wt % |
|---|---|
| Water | 53.01-62.93 |
| Phenoxy ethanol | 0.1-10.0 |
| Benzisothiazolinone (84% A.I.) | 22.6 |
| Potassium hydroxide (50% solution) | 14.00 |
| Glutamic acid, N,N-diacetic acid tetrasodium | 0.37-0.39 |
| salt (GLDA-Na₄) | |

pH of the solution is 8.9

### Example 13

Aqueous solution of BIT, Phenoxy ethanol,
capryl alcohol and chelating agent

| Ingredients | Wt % |
|---|---|
| Water | 43.01-62.93 |
| Phenoxy ethanol | 0.1-10.0 |
| Capryl alcohol | 0.1-10 |
| Benzisothiazolinone (84% A.I.) | 22.6 |
| Potassium hydroxide (50% solution) | 14.00 |
| Glutamic acid, N,N-diacetic acid tetrasodium | 0.37-0.39 |
| salt (GLDA-Na₄) | |

pH of the solution is 8.7

### Example 14

Aqueous solution of BIT, Salicylic acid and chelating agent

| Ingredients | Wt % |
|---|---|
| Water | 58.01-62.93 |
| Salicylic acid | 0.1-5.0 |
| Benzisothiazolinone (84% A.I.) | 22.6 |
| Potassium hydroxide (50% solution) | 14.00 |
| Glutamic acid, N,N-diacetic acid tetrasodium | 0.37-0.39 |
| salt (GLDA-Na₄) | |

pH of the solution is 8.6

### Example 15

Aqueous solution of BIT, Glutaraldehyde and chelating agent

| Ingredients | Wt % |
|---|---|
| Water | 43.01-62.93 |
| Glutaraldehyde/triazine/formaldehyde donors | 0.1-20.0 |
| Benzisothiazolinone (84% A.I.) | 22.6 |
| Potassium hydroxide (50% solution) | 14.00 |
| Glutamic acid, N,N-diacetic acid tetrasodium | 0.37-0.39 |
| salt (GLDA-Na₄) | |

pH of the solution is 8.8

### Example 16

Aqueous solution of BIT, Alkyl benzyl quaternary
ammonium compound and chelating agent

| Ingredients | Wt % |
|---|---|
| Water | 58.01-62.93 |
| Alkyl benzyl quaternary ammonium | 0.1-5.0 |
| compound | |
| Benzisothiazolinone (84% A.I.) | 22.6 |
| Potassium hydroxide (50% solution) | 14.00 |
| Glutamic acid, N,N-diacetic acid tetrasodium | 0.37-0.39 |
| salt (GLDA-Na₄) | |

pH of the solution is 9.1

### Example 17

Aqueous solution of BIT, Guanidine and chelating agent

| Ingredients | Wt % |
|---|---|
| Water | 58.01-62.93 |
| Guanidine | 0.1-5.0 |
| Benzisothiazolinone (84% A.I.) | 22.6 |
| Potassium hydroxide (50% solution) | 14.00 |
| Glutamic acid, N,N-diacetic acid tetrasodium | 0.37-0.39 |
| salt (GLDA-Na₄) | |

pH of the solution is 8.9

### Example 18

Aqueous solution of BIT, Cetyl ammonium
bromide and chelating agent

| Ingredients | Wt % |
|---|---|
| Water | 58.01-62.93 |
| Cetyl ammonium bromide | 0.1-5.0 |
| Benzisothiazolinone (84% A.I.) | 22.6 |
| Potassium hydroxide (50% solution) | 14.00 |
| Glutamic acid, N,N-diacetic acid tetrasodium | 0.37-0.39 |
| salt (GLDA-Na₄) | |

pH of the solution is 8.5

### Example 19

Aqueous solution of BIT, Menthol, Eugenol and chelating agent

| Ingredients | Wt % |
|---|---|
| Water | 56.01-62.93 |
| Menthol | 0.1-2.5 |
| Eugenol | 0.1-2.5 |
| Benzisothiazolinone (84% A.I.) | 22.6 |
| Potassium hydroxide (50% solution) | 14.00 |
| Glutamic acid, N,N-diacetic acid tetrasodium | 0.37-0.39 |
| salt (GLDA-Na₄) | |
| Tween 20 | 2.0 |

pH of the solution is 8.7

While this invention has been described in detail with reference to certain preferred embodiments, it should be appreciated that the present invention is not limited to those precise embodiments. Rather, in view of the present disclosure, which describes the current best mode for practicing the invention, many modifications and variations would present themselves to those skilled in the art without departing from the scope and spirit of this invention.

What is claimed is:

1. An environment-friendly highly aqueous clear solution of 1,2-benzisothiazolin-3-one (BIT) comprising: (i) about 0.1% to about 30% by wt. of 1,2-benzisothiazolin-3-one; (ii) about 5% to about 15% by wt. of neutralizing agent; (iii) about 50% to about 85% by wt. of water; and (iv) about 0.1% to about 5% by wt. of chelating agent; and wherein said aqueous solution is free from volatile organic compounds (VOC's), glycerols, derivatives of glycerols, glycols and/or derivatives of glycols.

2. The aqueous solution of BIT according to claim 1, further comprising at least one water soluble form of co-biocide selected from the group consisting of phenolic compounds, alkali metal salts of isothiazolinones, quaternary ammonium salts, triazine derivatives, guanidine compounds, biguanides, poly biguanides, salts of organic acids, fatty amines, diamines, triamines, salts of pyrithione, copper salts, thiocyanates, carbamates, dithiocarbamates, hydantoins, silver based compounds, copper based compounds, formaldehyde releasing compounds, formaldehyde, glutaraldehyde, propionic acid salt, octanoic acid salt, salicylic acid salt, dehydroacetic acid salt, bronopol, phenoxy ethanol, menthol, eugenol, capryl alcohol, coco amine acetate, N-dodecyl-1,3-propanediamine, bis-(3-aminopropyl)dodecylamine, chlorhexidine, alexidine, sodium hydroxymethylglycinate, dimethyloldimethylhydantoin, polyhexamethylene biguanide, diazolidinyl urea, imidazolidinyl urea, polymethoxy bicyclic oxazolidines, benzyl alcohol, hexamidine isethionate, chlorobutanol, dibromopropamidine, tetrakis (hydroxymethyl)phosphonium sulfate (THPS), 2,2-dibromo-3-nitrilopropionamide (DBNPA), tri n-butyl tetradecyl phosphonium chloride (TPC), methylene bis(thiocyanate) (MBT), alkyl dithiocarbamates, alkylene dithiocarbamates, 2-hydroxypyridine-N-oxide, N-nitroso-N-cyclohexyl-hydroxylamine, and/or 8-hydroxy-quinoline.

3. The aqueous solution of BIT according to claim 1, wherein said neutralizing agent is selected from the group consisting of alkali metal hydroxides and/or amines.

4. The aqueous solution of BIT according to claim 1, wherein the neutralizing agent is sodium hydroxide (NaOH) or potassium hydroxide (KOH).

5. The aqueous solution of BIT according to claim 1, wherein the neutralizing agent is homo or copolymers of polyamines, polyimines, polyalkyleneimines, polyethyleneimines, polypropyleneimines alone or in combination.

6. The aqueous solution of BIT according to claim 1, wherein the neutralizing agent is alkanolamines, mono-alkyl alkanolamines, di-alkyl alkanolamines, tri-alkyl alkanolamines, primary amines, secondary amines, tertiary amines, quaternary amines and/or alkyl tertiary amines, phenol amines alone or in combination.

7. The aqueous solution of BIT according to claim 1, wherein the neutralizing agent is polyethyleneimines (PEI).

8. The aqueous solution of BIT according to claim 1, wherein said chelating agent is selected from the group consisting of hydroxy-carboxylic acids, aminocarboxylic acids, phosphonic acids, crown ethers, amino acids, ethylene diamine tetraacetic acid, nitrosotrihydroxy-dipropylamine, nitriloacetate, acetyl salicylate and/or gluconic acid salts.

9. The aqueous solution of BIT according to claim 1, wherein said chelating agent is glutamic acid-N, N-diacetic acid tetrasodium salt.

10. The aqueous solution of BIT according to claim 1, wherein the pH is from about 8.5 to about 9.5.

11. The aqueous solution of BIT according to claim 1 capable of inhibiting or killing gram (+) bacterial strains, gram (−) bacterial strains, fungi, yeasts and/or mold spores.

12. The aqueous solution of BIT according to claim 1 capable of inhibiting or killing Staphylococcus aureus, Staphylococcus epidermidis, Streptococcus pneumoniae, Streptococcus pyogenes, Enterococcus faecalis, Haemophilus influenzae, Moraxella species, salmonella species, campylobacter species, Pseudomonus aeruginosa, Clostridium botulinum, Clostridium perfringens, Corynebacteria species, Diplococci species, Mycobacteria species, Streptomyces species, Escherichia coli, Salmonella typhimurium, Salmonella enteritidis, Vibrio parahaemolyticus, Bacillus anthracis, Bacillus azotoformans, Bacillus cereus, Bacillus coagulans, Bacillus israelensis, Bacillus larvae, Bacillus mycoides, Bacillus polymyxa, Bacillus pumilis, Bacillus stearothormophillus, Bacillus subtilis, Bacillus thuringiensis, Bacillus validus, Bacillus weihenstephanensis, Bacillus pseudomycoides, Burkholderia cepacia, Burkholderia multivorans, Burkholderia cenocepacia, Burkholderia vietnamiensis, Burkholderia stabilis, Burkholderia ambifaria, Burkholderia dolosa, Burkholderia anthina, Burkholderia pyrrocinia, Candida tropicalis, Candida albicans, Hansenula anomala, Saccharomyces cerevisiae, Torulaspora delbreuckii, Zygosaccharomyces bailii, Zygosaccharomyces rouxii, Aspergillus niger, Aspergillus flavus, Penicillium islandicum, Penicillium citrinum, Penicillium chrysogenum, Fusarium oxysporum, Fusarium graminearum, Fusarium solani, Alternaria alternata, and/or Mucor racemosus.

13. The aqueous solution of BIT according to claim 1 that is stable for at least two years at ambient temperature or stable for at least 5 freeze/thaw cycles when the temperature is cycled from 50° C. to −24° C. in every 24 hours or stable for at least 4 weeks at about 50° C.

14. The aqueous solution of BIT according to claim 1, wherein the BIT of aqueous solution is non-crystallizable at ambient temperature or greater than 0° C.

15. The aqueous solution of BIT according to claim 1 that is storage and transit stable.

16. The aqueous solution of BIT prepared according to claim 1 employed in the field of paint, building materials, stucco, concrete, caulks, sealants, joints, adhesives, leather, wood, inks, pigment dispersions, metal working fluids, drilling mud, clay slurries, agricultural applications, seed coatings, pesticide compositions, toiletry, household, cleaning, disinfecting, enzyme formulations, latex, paint, in-can preservation, coatings and/or laundry.

17. An environment-friendly highly aqueous solution of 1,2-benzisothiazolin-3-one (BIT) comprising: (i) about 0.1% to about 30% by wt. of 1,2-benzisothiazolin-3-one; (ii) about 5% to about 15% by wt. of potassium hydroxide (KOH); (iii) about 50% to about 85% by wt. of water; and (iv) about 0.1% to about 5% by wt. of glutamic acid-N,N-diacetic acid tetrasodium salt; and wherein said aqueous solution is free from volatile organic compounds (VOC's), glycerols, derivatives of glycerols, glycols and/or derivatives of glycols.

18. An environment-friendly highly aqueous solution of 1,2-benzisothiazolin-3-one (BIT) comprising: (i) about 0.1% to about 30% by wt. of 1,2-benzisothiazolin-3-one; (ii) about 0.1% to about 20.0% of bronopol; (iii) about 5% to about 15% by wt. of potassium hydroxide (KOH); (iv) about 60% to about 80% by wt. of water; and (v) about 0.1% to about 5% by wt. of glutamic acid-N,N-diacetic acid tetrasodium salt; and wherein said aqueous solution is free from volatile organic compounds (VOC's), glycerols, derivatives of glycerols, glycols and/or derivatives of glycols.

19. An environment-friendly highly aqueous solution of 1,2-benzisothiazolin-3-one (BIT) comprising: (i) about 0.1% to about 30% by wt. of 1,2-benzisothiazolin-3-one; (ii) about 0.1% to about 5.0% by wt. of water soluble form of 2-methyl-4-isothiazolin-3-one (MIT) and/or 5-Chloro-2-methyl-4-isothiazolin-3-one (CMIT); (iii) about 5% to about 15% by wt. of potassium hydroxide (KOH); (iv) about 45% to about 85% by wt. of water; and (v) about 0.1% to about 5% of glutamic acid-N,N-diacetic acid tetrasodium salt; and wherein said aqueous solution is free from volatile organic compounds (VOC's), glycerols, derivatives of glycerols, glycols and/or derivatives of glycols.

20. A process for preparing an environment-friendly highly aqueous solution of 1,2-benzisothiazolin-3-one (BIT) comprising the steps of:
i. preparing a homogenous mixture of (a) pre-neutralized 1,2-benzisothiazolin-3-one (BIT); (b) optionally, at least one water soluble form of co-biocide; (c) a chelating agent; and (d) water by high shear mixing in a reactor for 30 minutes; and
ii. adding an antifoaming agent to suppress the formation of foam if any.
